(19) United States
(12) Patent Application Publication
(10) Pub. No.: US 2013/0159023 A1
(43) Pub. Date: Jun. 20, 2013

(54) SYSTEM AND METHOD FOR EVIDENCE BASED DIFFERENTIAL ANALYSIS AND INCENTIVES BASED HEAL THCARE POLICY

(71) Applicants: Neela SRINIVAS, Cupertino, CA (US); Srinivas KUMAR, Cupertino, CA (US)

(72) Inventors: Neela SRINIVAS, Cupertino, CA (US); Srinivas KUMAR, Cupertino, CA (US)

(21) Appl. No.: 13/328,011

(22) Filed: Dec. 16, 2011

(51) Int. Cl. G06Q 40/08; G06Q 50/22

(52) U.S. Cl. 705/4; 705/14.17

(57) ABSTRACT

An evidence based cost modeling and predictive analysis system, and an incentives based plan to reduce healthcare costs are disclosed. An analytics system may generate incremental expenditures among overweight and obese individuals, predictive forecasts of future medical costs, and predictive forecast of cost reduction based on financial incentives to recipients. The forecasts may include statistical trends, prevalence of diseases based on body mass index, and medical evidence associated with specific illnesses. A computer based program may process and analyze dependent and independent variables in electronically stored information (for example insurance, health and medical records). A health insurance provider may provide an annual rebate on paid premiums to recipients based on a qualifying annual BMI as an incentive. The recipients may receive the rebates in a qualified health reimbursement account (HRA) managed by the recipients towards future healthcare related expenditures.

### BACKGROUND OF THE DISCLOSURE

1. Field of the Disclosure

This invention relates to the field of health insurance and, more particularly, to a system and method to reduce healthcare costs with an incentive-based plan to achieve a healthy body mass index (BMI) and evidence based predictive and differential analysis of relevant compound risks and incremental lifetime expenditures.

2. Description of the Related Art

The rising cost of insurance premiums and out-of-pocket expenses for healthcare, and an increasing population at risk with inadequate or no health insurance across all age groups, is becoming a cause of concern to governments and private healthcare industry at large. The projected cost of coverage to insurance companies based on trends in lifestyles and emerging patterns of diseases is alarming and is a serious challenge to the industry.

The Patient Protection and Affordable Care Act (PPACA) is a United States federal statute signed into law in 2010. PPACA requires health insurance companies in the United States to increase insurance coverage of pre-existing conditions, and spend 80 to 85 percent of premium dollars on medical care and health care quality improvement, rather than on administrative costs, starting in 2011. Insurance companies that do not meet the medical loss ratio standard provision will be required to provide rebates to their consumers, payable by August 1^{st} each year, starting in 2012. Enrollees, to whom rebates are owed, will receive a premium reduction rebate check or lump-sum reimbursement to a credit or debit card account. Pursuant to National Association of Insurance Commissioners (NAIC) recommendations, the regulation specifies quality improvement activities grounded in evidence-based practices, for innovations counted toward the 80 or 85 percent standard.

### SUMMARY OF THE DISCLOSURE

Certain exemplary embodiments of the present disclosure provide an apparatus and/or system to predict relevant future expenditures for facility and treatment based on a plurality of dependent and independent variables, weighted by body mass index (BMI) influencers.

According to an exemplary embodiment, the present disclosure provides a method, apparatus, and/or system for a plurality of services that enable quality improvement activities grounded in evidence based practices and affordability of preventive and curative medical treatment based on a plurality of factors.

Certain exemplary embodiments may include a method, apparatus and/or system to establish medical insurance premiums and deductibles based on, or adjusted for, BMI.

Certain exemplary embodiments may include a method, apparatus and/or system for proactive measures to increase the likelihood of desired health outcomes based on BMI.

Certain exemplary embodiments may include a method, apparatus and/or system to estimate incremental lifetime healthcare expenditures among overweight and obese individuals with specific illnesses,

Certain exemplary embodiments may include a method, apparatus and/or system for a computer based program (e.g., web or non-web application or service) to process and analyze datasets (for example, electronic insurance, medical and health records, etc.). The system may include differential analysis, statistical analysis and modeling using a plurality of data sources and filters to generate multiple reports and perspective data views. The report may represent risk analysis, mitigated risks, predictive forecasts of costs, and predictive forecasts of savings based on mitigated risks.

The computer based program may be configured to include (e.g., embedded or over secure communications channels) datasets of disease onset trends, patient profiles, and treatment patterns from structured and semi-structured datasets from multiple data providers.

Certain embodiments may be embodied as a method, apparatus and/or system that may include a professional (enterprise) service to healthcare providers as a web or non-web based subscription.

Certain embodiments may also be embodied as a method, apparatus and/or system that may include a personalized service to healthcare recipients as a web or non-web based subscription.

Certain exemplary embodiments may include a method, apparatus and/or system to create a health reimbursement account (HRA) for members (healthcare recipients, families, etc.) wherein an annual rebate (for example, a refund calculated as a percentage of paid premiums) is offered as a reimbursement on achieving a healthy BMI for the year.

Certain exemplary embodiments may include the use of the HRA funds for: (1) deductibles; (2) out-of-pocket expenses; (3) health club membership fees; (4) weight loss programs; and/or (5) other activities to promote desired health outcomes for recipients.

Certain exemplary embodiments may include a method, apparatus and/or system to influence the food industry including, for example, one-off production, batch production, mass production and just-in-time production, to adopt desired consumer health outcome conscious approaches, based on BMI influencers.

These and other features of the present disclosure will be readily appreciated by one of ordinary skill in the art from the following detailed description of various implementations when taken in connection with the accompanying drawings.

### BRIEF DESCRIPTION OF THE DRAWING FIGURES

The disclosure is best understood from the following detailed description when read in connection with the accompanying drawings. According to common practice, various features/elements of the drawings may not be drawn to scale. Common numerical references represent like features/elements. The following figures are included in the drawings:

FIG. 1 is a schematic diagram illustrating an exemplary system/architecture in accordance with various exemplary embodiments;

FIG. 2 is a schematic diagram illustrating a method to model cause-effect and prevention-treatment relationships in accordance with various exemplary embodiments of the disclosed system;

FIG. 3 is a schematic diagram illustrating method of modeling cost flows for affordable and sustainable healthcare services in accordance with various exemplary embodiments of the disclosed system;

FIG. 4 is a flowchart illustrating a method for providing a first part of a model for statistical analysis to compute healthcare expenditures in accordance with various exemplary embodiments of the disclosed system;

FIG. 5 is a flowchart illustrating a method for providing a second part of the model for statistical analysis to compute healthcare expenditures in accordance with various exemplary embodiments of the disclosed system;

FIG. 6 is a flowchart illustrating a method for providing statistical analysis, based on the first and second parts of the model illustrated in FIGS. 4 and 5, to compute healthcare expenditures in accordance with various exemplary embodiments of the disclosed system; and

FIG. 7 is a flowchart illustrating a method for providing statistical analysis to compute healthcare cost reductions, prevalence of individuals with inadequate activities in daily living and functional limitations, and total expenditures for the population with the illness in accordance with various exemplary embodiments of the disclosed system; and

FIG. 8 is a graphical representation illustrating a method for providing differential analysis of predicted lifetime costs and predicted cost reductions in accordance with various exemplary embodiments of the disclosed system.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

Although the disclosure is illustrated and described herein with reference to specific embodiments, the invention is not intended to be limited to the details shown herein. Rather, various modifications may be made in the details within the scope and range of equivalents of the claims and without departing from the scope of the disclosure.

National representative estimates of expenditures for the United States population for diseases common to overweight and obese individuals by years since time of diagnosis may be estimated using one among a plurality of regression analysis techniques.

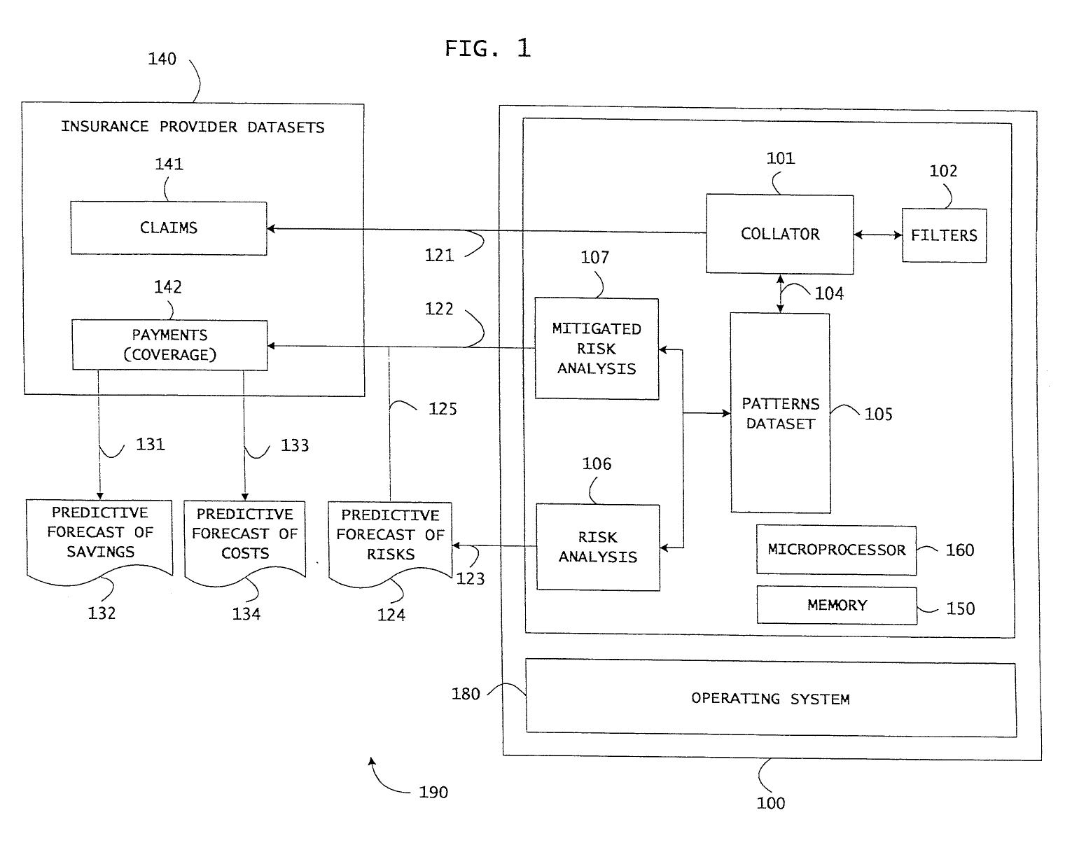

FIG. 1 is a schematic diagram illustrating an exemplary predictive analysis system 190 in accordance with various exemplary embodiments.

Referring to FIG. 1, the predictive analysis system 190 includes a services platform 100 and insurance provider datasets 140 including electronic claims repositories 141 and insurance payments (or coverage plans) datasets 142. The services platform includes an operating system 180, microprocessor 160, a memory 150, a collator 101 to consolidate multiple disparate datasets, at least one relevant filter 102 to include various elements contained in the datasets, a means to generate trends and build a patterns dataset 105, a means to perform risk analysis 106, a means 123 to estimate predictive forecast of risks 124, a means to perform mitigated risk analysis 107, a means to import datasets 121 from an insurance provider's electronic claims repositories 141, a method to import datasets 122 from insurance payments (or coverage plans) datasets 142, a means 131 to generate predictive forecast of cost reductions (savings) 132, a means 133 to generate predictive forecast of costs (payments) 134, and a means 125 to generate predictive forecast of costs 134. The insurance provider datasets 140 may include a plurality of electronically stored information, for example, insurance, medical and/or health records.

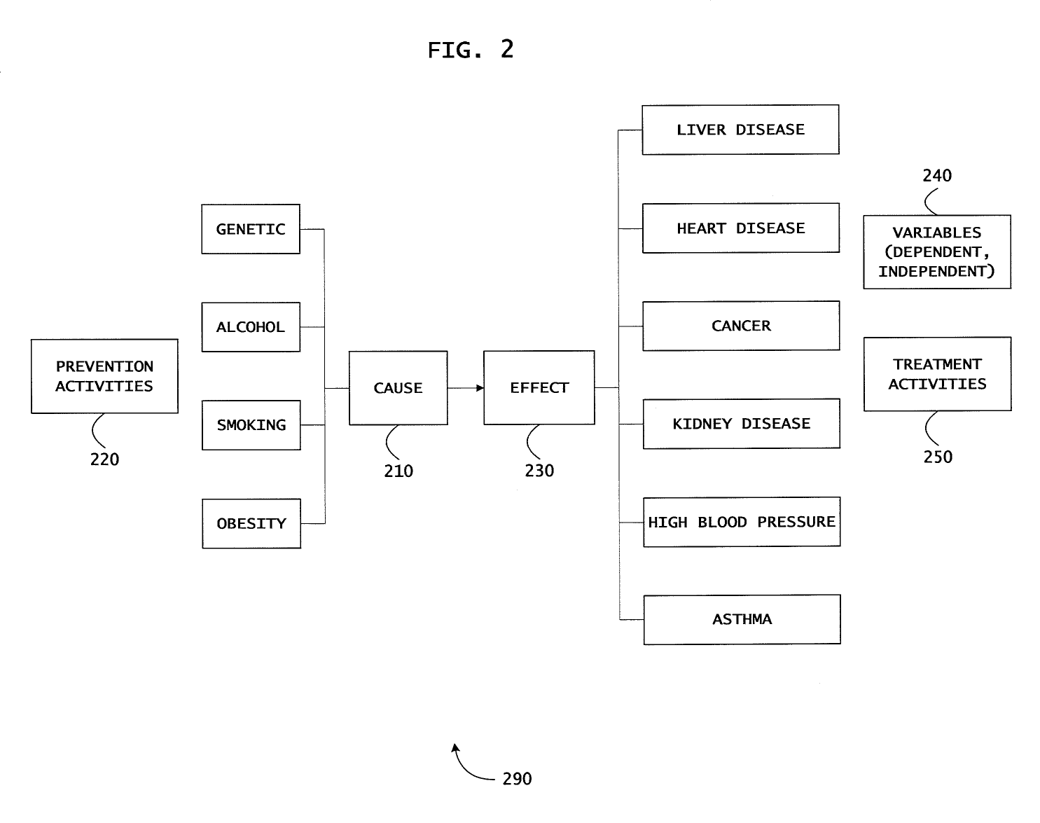

FIG. 2 is a schematic diagram illustrating an exemplary cause and effect relationship modeling system 290 in accordance with various exemplary embodiments.

Referring to FIG. 2, the cause-effect relationship modeling system 290 includes a means for cause analysis 210 (for example, illnesses correlated to genetics, alcohol, smoking, obesity, etc.), a means for effect analysis 230 (for example, illnesses as liver disease, heart disease, cancer, kidney disease, high blood pressure, asthma, etc.), prevention activities database 220, treatment activities database 250, and a plurality of dependent and independent variables 240.

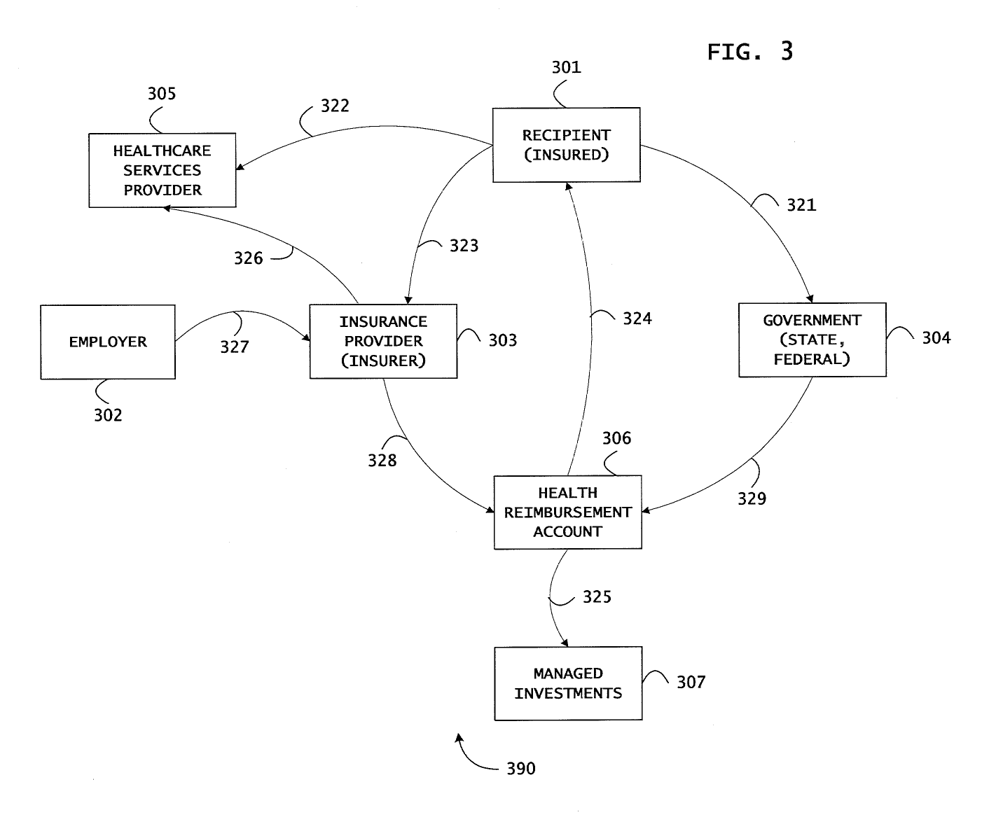

FIG. 3 is a schematic diagram illustrating an exemplary incentive based healthcare policy 390 in accordance with various exemplary embodiments.

Referring to FIG. 3, the healthcare incentives system 390 includes a health insurance recipient 301, an insurance provider 303, a government entity (state or federal) 304, a healthcare services provider 305, an employer 302 of the recipient 301, a healthcare reimbursement account 306 of the recipient 301, managed investments 307, government tax collections (income, social security, Medicare, etc.) 321, a matching healthcare contribution by a government entity 329, a healthcare expense (for example, co-payments, deductibles, etc.) 322, an out-of-pocket health insurance premium 323, a healthcare claim payment 326, an employer-paid healthcare premium 327, an insurance reimbursement 328 to the health reimbursement account 306 and contributions 325 to managed investments 307.

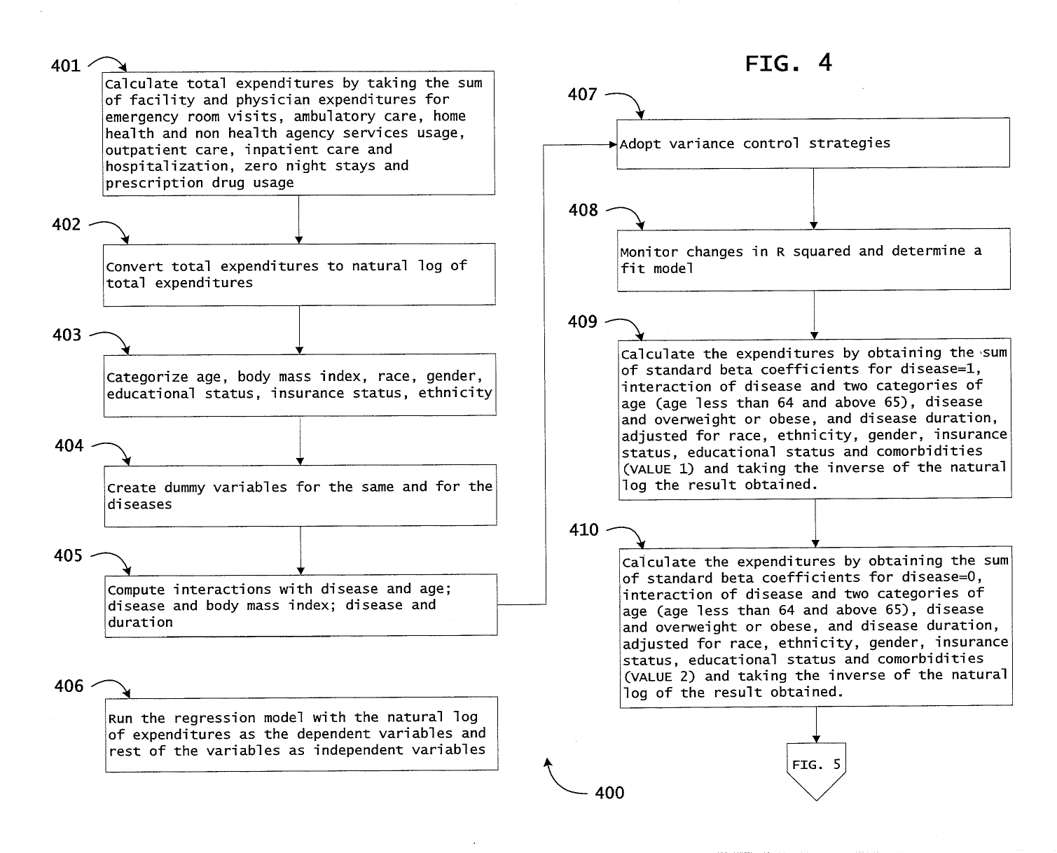

FIG. 4 is a flowchart illustrating a method 400 in accordance with various exemplary embodiments. The method 400 provides a first part of the model for statistical analysis on datasets to compute healthcare expenditures based on a plurality of variables.

At block 401 of FIG. 4, for the first part of the model, the total expenditures for diseases are calculated using the sum of facility and physician expenditures for emergency room visits, ambulatory care, home health and non health agency services usage, outpatient care, inpatient care and hospitalization, zero night stays and prescription drug usage during the year. The diseases, for which total expenditures are calculated, are identified using standardized International Classification of Diseases (ICD) codes, diabetes (DIABDX, ICD 9 code ‘250’), heart disease (angina or myocardial infarction or other heart disease or coronary heart disease, ICD 9 codes 410, 412, 413, 414, 415, 416, 423,424, 426,427,428,429), high blood pressure (BPMLDX, ICD 9 Code 401), stroke (STRKDX, ICD 9 codes 430-436), arthritis (ARTHDX, ICD 9 code715.00-715.98), mental diseases (ICD9 codes for depression, anxiety, alcoholism, drug abuse: ‘295’, ‘296’, ‘311’, ‘312’, ‘313’, ‘296’, ‘300’, ‘301’, ‘303’, ‘304’, ‘305’, ‘309’), cancer (breast cancer: ICD9CODX, ‘174’, ‘V10’, ‘85’)); Colon Cancer: ICD 9 codes, ‘153’, ‘154’, ‘V10’, ‘45’, ‘49’)).

At block 402, values of total expenditures greater than zero are converted to natural log of expenditures.

At block 403, the independent variables from the dataset include at least age, BMI, race, gender, ethnicity, education status, diseases (diabetes, high blood pressure, heart disease, stroke, breast cancer, prostate cancer, arthritis, mental conditions), duration of illness (0 and 45 years), insurance status, and interactions of the disease with its duration, age and BMI. The individuals may be categorized into two age groups, 0-64 (coded as 1 for age 0-64 and 0 for age 65 and above) and above 65 years (coded as 0 for age 0-64 and 1 for age 65 and above). The BMI for adults 18 years of age or older may be categorized as healthy weight (BMI less than 24.99), and overweight (BMI between 25 and 29.99) or obese (BMI above 30). For children 0-17 years, BMI may be calculated using the formula (weight (lb)/height (in) 2)*703. The BMI computed may be plotted on the BMI for age charts and children may be categorized based on the percentile for age. Children 0-17 years of age who are less than 5th percentile in the ‘BMI for age chart’ may be considered underweight; between 5th and 85th percentile as healthy weight, 85th to less than 95th percentile as overweight and above 95th percentile as obese. The race may be categorized as White (Caucasian), Black, American Indian/Alaskan Native, Asian, Native Hawaiian, Multiple race; Ethnicity may be categorized as Hispanic, Non-Hispanic; Education Status 1 through 8 years of education may be coded as elementary education; 9 through 12 years of education as high school; 13-17 years of education as college and else as system missing; Insurance Status may be categorized as private, public (for example Medicare, Medicaid, Tricare, SCHIP or other public programs), and uninsured. Gender may be categorized as Male or Female.

At block 404, all the variables are dummy coded. At block 405, interactions with disease and age; disease and body mass index; disease and duration are computed.

Since the datasets may comprise of multiple zero values to represent bad debt, free care, etc., a two part regression model is adopted in the prediction of expenditures. At block 406, the first part of the model, a regression model on the subsample of individuals with expenses is used to model a relationship between the dependent variable, natural log of the expenses and the independent variables.

At block 407, variance control strategies are adopted. In certain exemplary embodiments, Taylor series linearization method to use Variance Estimation Strata (VARSTR) and Variance Estimation Primary Sampling Units (VARPSU) within the strata may be adopted to obtain variability of the survey estimates of expenditures of medical illnesses. The data may be weighted by person weight.

At block 408, changes in R squared are monitored to determine a fit model.

At block 409, expenditures are predicted for individuals with illness by obtaining the sum of standard beta coefficients of the illness (disease=1), and its interaction with its duration, overweight or obese, and age; adjusting for race, ethnicity, gender, insurance status, and educational status among overweight or obese over one year in log dollars. The log dollars may be converted to raw dollars by taking the ‘inverse of the log’ to obtain value 1.

At block 410, expenditures are predicted for individuals without the illness by obtaining the sum of standard beta coefficients of the illness (disease=0), and its interaction with its duration, overweight or obese, and age; adjusting for race, ethnicity, gender, insurance status, and educational status among overweight or obese over one year in log dollars. The log dollars may be converted to raw dollars by taking the ‘inverse of the log’ to obtain value 2.

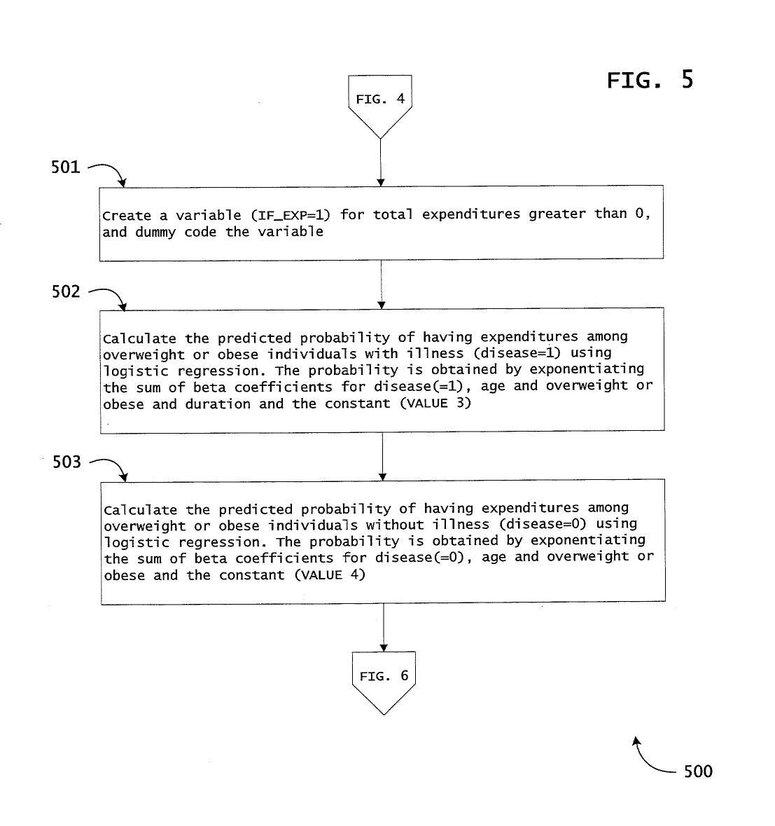

FIG. 5 is a flowchart illustrating a method 500 in accordance with various exemplary embodiments. The method 500 provides a second part of the model (i.e., continuation of the first part depicted in FIG. 4) for statistical analysis on datasets to compute healthcare expenditures based on a plurality of variables.

At block 501, a variable IF_EXP may be created for total expenditures greater than zero and the variable may be dummy coded, for the second part of the model.

At block 502, the second part of the model uses binary logistic regression to predict the probability of having expenditure among overweight or obese individuals with illness (disease=1). The dependent variable IF_EXP (set to 1 if individual has expenditure and 0 if no expenditure), and independent variables may be the same as the ones used in the first part of the model. The probability of predicting expenses among individuals with the illness may be calculated from exponentiation of B or e^{B}, where B is the sum of the coefficients of the disease, and its interaction with its duration, overweight or obese, and age; adjusting for race, ethnicity, gender, insurance status, and educational status to obtain value 3.

At block 503, the second part of the model uses binary logistic regression to predict the probability of having expenditure among overweight or obese individuals without the illness (disease=0). The dependent variable IF EXP (set to 1 if individual has expenditure and 0 if no expenditure), and independent variables may be the same as the ones used in the first part of the model. The probability of predicting expenses among individuals without the illness is calculated from exponentiation of B or e^{B}, where B is the sum of the coefficients of the disease, and its interaction with its duration, overweight or obese, and age; adjusting for race, ethnicity, gender, insurance status, and educational status to obtain value 4.

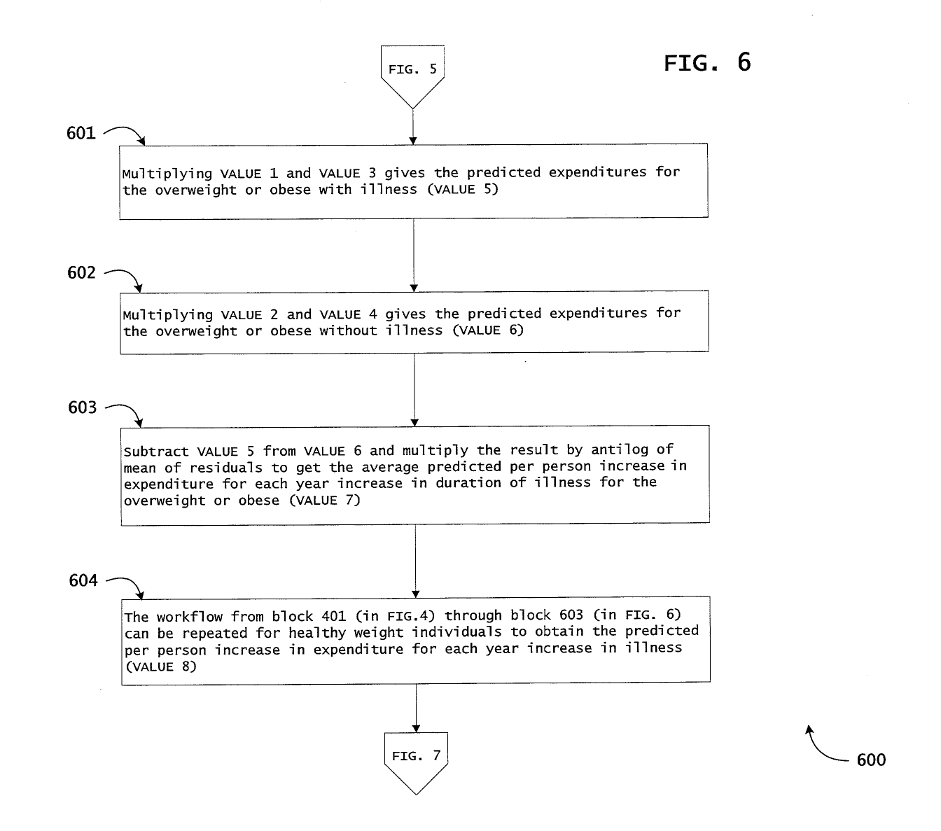

FIG. 6 is a flowchart illustrating a method 600 in accordance with various exemplary embodiments. The method 600 provides statistical analysis on datasets, based on the first and second parts of the model (depicted in FIGS. 4 and 5), to compute healthcare expenditures based on a plurality of variables.

At block 601, the predicted expenditure incurred for overweight or obese individuals with illnesses is obtained by multiplying the predicted probability of having expense (value 3) from the second part of the model by its predicted expenditure obtained from the first part of the model (value 1), with resulting value 5.

At block 602, the predicted expenditure incurred for overweight or obese individuals without illnesses is obtained by multiplying the predicted probability of having expense from the second part of the model (value 4) by its predicted expenditure obtained from the first part of the model (value 2), with resulting value 6.

At block 603, the difference in expenditure (value 7) obtained by subtracting value 5 from value 6 is the predicted average per person increase in expenditure. To correct for transformation bias, the increase (value 7) is multiplied by the Bias Correction Factor (BCF) or the smearing factor. The smearing factor is calculated by taking the antilog of the mean of the residuals.

At block 604, the first and second parts of the model may be reapplied to calculate the expenditures for healthy weight individuals with the illness in the sample (value 8).

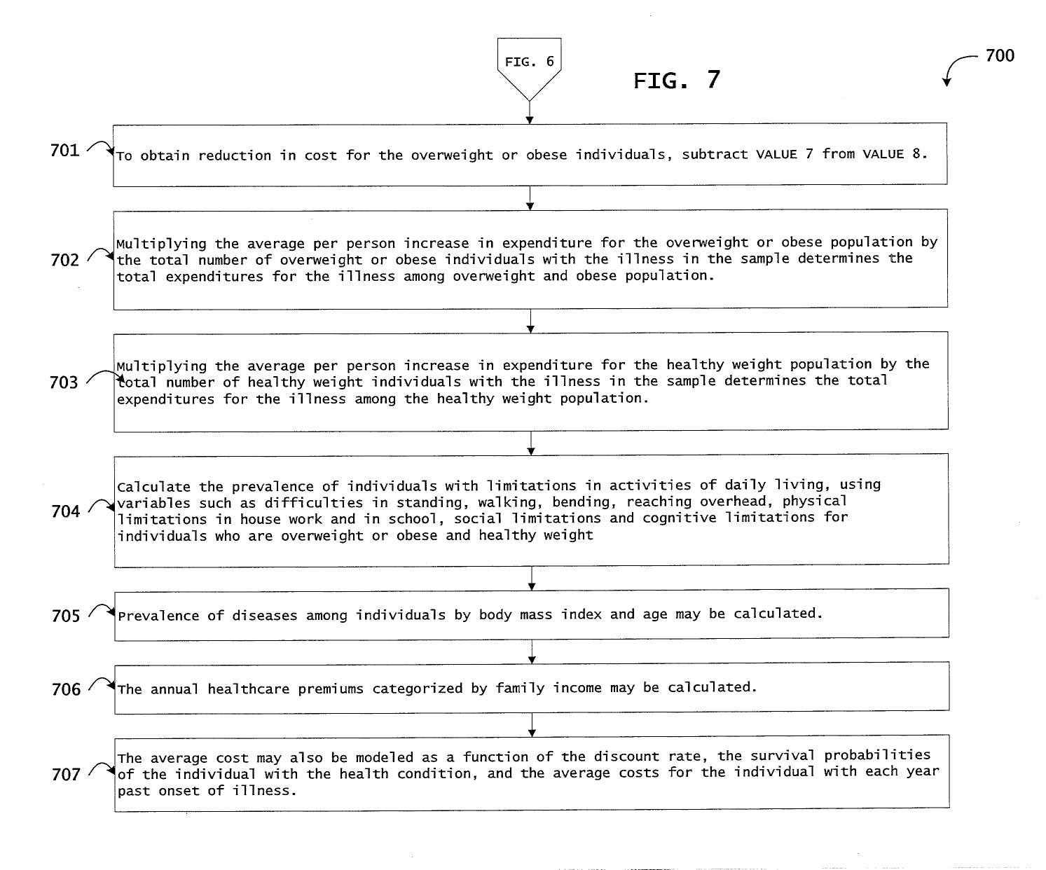

FIG. 7 is a flowchart illustrating a method 700 in accordance with various exemplary embodiments. The method 700 provides statistical analysis on datasets to compute healthcare cost reductions, prevalence of individuals with inadequate activities in daily living and functional limitations, and total expenditures for the population with the illness.

At block 701, cost reduction is calculated as the weighted average of difference in predicted expenses between overweight or obese (value 7) and healthy weight (value 8) individuals with the specific illness.

At block 702, multiplying the average per person increase in expenditure for the overweight and obese population by the total number of overweight and obese individuals with the illness in the sample may determine the total expenditures for the overweight and obese population with illness.

At block 703, multiplying the average per person increase in expenditure for the healthy weight population by the total number of healthy weight individuals with the illness in the sample may determine the total expenditures for the healthy weight population with illness.

At block 704, the prevalence of individuals with inadequate Activities of Daily Living (ADL) and functional limitations using variables such as difficulties in standing, bending, reaching overhead, physical limitations, house work limitations, social and cognitive limitations, among the overweight or obese individuals and healthy weight individuals may be calculated. Reducing weight is expected to improve ADL.

At block 705, the prevalence of diseases among individuals by BMI and age may be calculated. At block 706, the annual healthcare premiums categorized by family income may be calculated. At block 707, the average cost may also be modeled as a function of the discount rate, the survival probabilities of the individual with the health condition, and the average costs for the individual with each year past onset of illness.

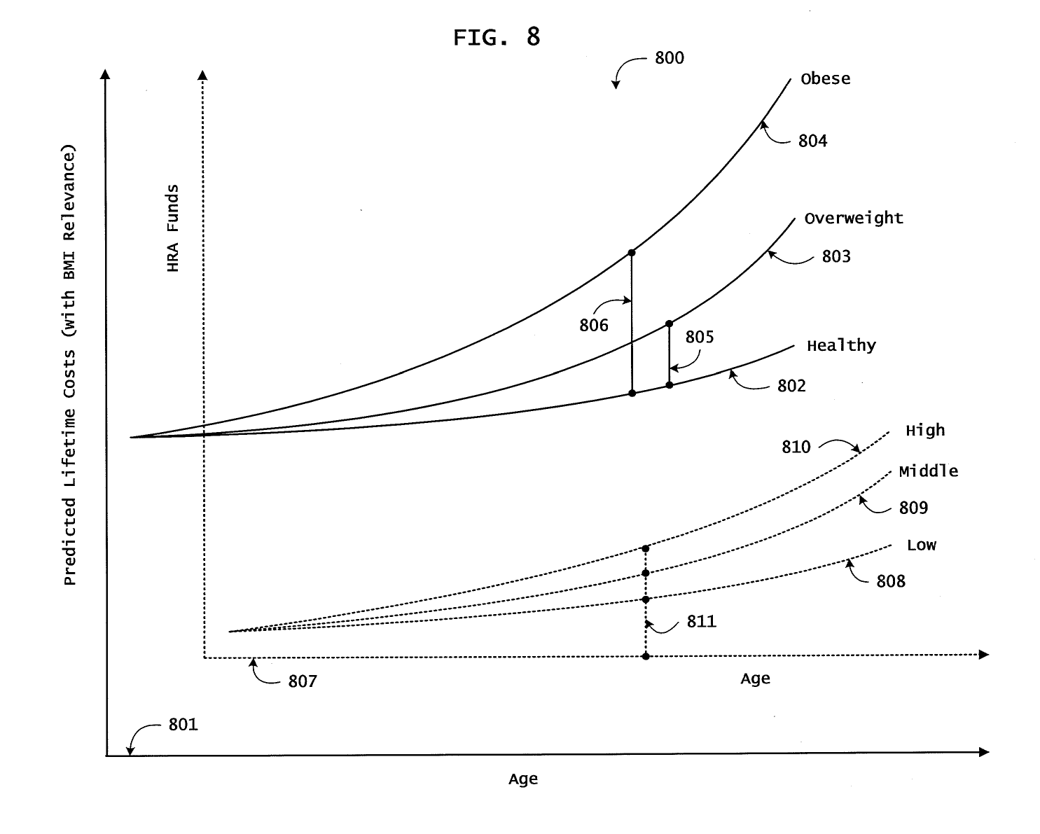

FIG. 8 is a graphical representation illustrating differential analysis, generated from a calculus on datasets, of predicted lifetime costs and predicted cost reductions based on projected availability of HRA funds, by age and category.

At reference point 801, lifetime healthcare costs with BMI relevance (including at least out-of-pocket expenses and insurance payments) are predicted by age and BMI category. Reference points 802, 803 and 804 exemplify the predicted cost trajectories for populations in healthy, overweight and obese BMI categories respectively. Reference points 805 and 806 exemplify the cost reductions realized by achieving a healthy BMI in populations.

At reference point 807, availability of HRA funds may be predicted by age and income category. Reference points 808, 809 and 810 exemplify the predicted trajectory of reserves in HRA for populations in the low, middle and high-income categories respectively. Reference point 811 exemplifies predicted funds available through the HRA at the age of onset of medical treatments to offset predicted healthcare expenses, thereby reducing direct payments to healthcare recipients by the healthcare insurance provider.

The predictive analytics are performed on electronically stored information (raw data representation). The results of the analysis may be used to predict the incidence (occurrence) risks and lifecycle (for example, onset, duration, etc.) of specific diseases and the lifetime payments for such illnesses (or diseases) by insurance providers (for example, federal or state governments, private, etc.).

The forecasting of medical expenditures based on BMI provides insurance providers the ability to monitor high risk recipients (members) and implement quality improvement initiatives to mitigate evidence based risks taking into account the specific needs of members to increase the likelihood of desired health outcomes. The predictive analysis may be rendered as electronically stored information and shared with healthcare services providers (for example, hospitals, physicians, home-hospice, etc.) to facilitate appropriate guidance and decisions in patient care.

The predictive analysis model includes a plurality of independent variables that cause or promote obesity. These medical evidences may include at least the family history, age of onset of obesity, injury history, sleep disorders, effect of enzymes and other proteins in the blood, hormonal imbalances, endocrinological disorders, genetics, drug influences, emotions (e.g., boredom, sadness, anger, etc.), environmental influences, surgical history, allergies, eating disorders, religious activities, social activities, social influences (e.g., bullying, abuse, etc.), and regular diet composition (e.g., meat, fish, poultry, fruits, vegetables, formula foods, genetically modified foods, alcohol, etc.).

In one exemplary embodiment, a calculus estimates the average per person increase in predicted expenditures amongst BMI categories and the cost reduction as a cost differential when members achieve healthy BMI. BMI and a plurality of variables may be applied as categorical variables rather than continuous variables. Annual expenditures categorized by type of insurance provider for each disease may be calculated for BMI categories. The RAND Corporation Health Insurance Experiment (RAND HIE) two part model has been modified to estimate expenditures amongst BMI categories for each disease predisposed by obesity.

In another exemplary embodiment of the disclosed apparatus, system, and method, weighting in calculus may be performed by frequency of obese, overweight and healthy weight members with a disease in the appropriate age group in the estimation of expenditures for the associated disease.

The calculus hypothesizes improved Activities of Daily Living, after obese or overweight members achieve healthy BMI, as a measure of indirect benefit and compound effect on lifetime cost reduction.

In another exemplary embodiment of the present disclosure, the rebate incentives to participants may be proposed as a percentage of the income tax rate to categorize cost reductions by income group, to estimate compound lifetime reserves in a participant's HRA.

The BMI based incentives to recipients may significantly influence trends in the food industry specifically in terms of production and food labels of nutrition facts, based on direct effect on the desired health outcomes of recipients. A transformation may likely occur in the processed and fast food industry to meet the requirements of consumers and offer health-outcomes aware food products. The food industry may also self-regulate the salt and sugar content in processed foods to address specific conditions that may hamper BMI objectives of health conscious consumers. This may also initiate outcomes and risk-centric metrics in nutrition facts rather than a calorie-centric metric. Guidance, such as serving size based on BMI, may be offered through nutrition facts on food labels.

Where methods described above indicate certain events occurring in certain orders, the ordering of certain events may be modified. Moreover, while a process depicted as a flowchart, block diagram, etc., may describe the operations of the system in a sequential manner, it should be understood that many of the system's operations can occur concurrently.

Techniques consistent with the present disclosure provide, among other features, a system and method to reduce healthcare costs with an incentive-based plan to achieve a healthy body mass index (BMI) and evidence based predictive and differential analysis of relevant compound risks and incremental lifetime expenditures. While various exemplary embodiments of the disclosed system and method have been described above, it should be understood that they have been presented for purposes of example only, not limitation. The various disclosed embodiments are not exhaustive and do not limit the disclosure to the precise forms disclosed. Modifications and variations are possible in light of the above teachings or may be acquired from practicing of the disclosure, without departing from the breadth or scope. The scope of the invention is defined by the claims and their equivalents.

1. A method of predicting future healthcare payments, comprising:
building, by a services platform of processing apparatus, a cause-effect relationship and compound effect model based on a plurality of dependent and independent variables for obesity related illnesses;
collating, by a collator of the services platform, structured and semi-structured claims datasets;
generating, by the services platform, a patterns dataset based on a plurality of variables;
performing, by the services platform, risk assessments using differential and statistical regression analysis on electronically stored information including insurance, medical and health records; and
estimating, by the services platform, pre-disease and post disease incremental and relevant lifetime costs associated with obesity related illnesses based on prevalence, risks, a plurality of variables, onset, duration, treatments and payments for individuals with healthy and unhealthy body mass indexes (BMI).

2. A method of predicting reduction in future healthcare payments, comprising:
modeling, by a services platform of a processing apparatus, of relevant and incremental treatment costs for obesity related illnesses by onset and duration for healthy and unhealthy beneficiaries;
determining, by the services platform, mitigation of onset and duration of obesity related illnesses in populations at risk by achieving a healthy body mass index (BMI);
performing, by the services platform, risk assessments using differential and statistical regression analysis on electronically stored information including insurance, medical and health records; and
estimating, by the services platform, pre-disease and post-disease mitigated incremental and relevant lifetime costs associated with obesity related illnesses based on prevalence, risks, a plurality of variables, onset, duration, treatments and payments for individuals with healthy and unhealthy BMIs.

3. A method of providing incentives to health insurance recipients to achieve desirable health outcomes, comprising:
providing financial rebates as a percentage of paid premiums on meeting qualifying criteria on an annual basis;
establishing achievement of a healthy body mass index (BMI) for the annual period as a qualifying criteria;
establishing a healthcare reimbursement account for the recipients;
receiving contributions, from a health insurance provider, to the healthcare reimbursement account, said contributions being structured as an annuity calculated as a percentage of paid premiums;
managing of the reimbursement funds by the recipients for healthcare associated expenditures; and
matching annual contribution to the recipients health reimbursement account by the government.

4. A method of food production and classification of food labels for consumers by the food industry, comprising:
emphasizing nutritional packaged, fast, or just-in-time foods catering to healthy dispositions;
offering concessions to encourage desired healthy outcomes based on achieving healthy BMI; and
labeling of foods with information pertinent to body mass index (BMI), as a complement to calories and total fat as nutrition facts.

5. The method of claim 1, further comprising:
calculating total expenditures by summing facility and physician expenditures and converting the calculated total expenditures to a natural log.

6. The method of claim 5, wherein performing risk assessments using differential regression analysis includes analyzing relationships between the dependent variables, the independent variables, and the natural log.

7. The method of claim 1, wherein the independent variables include at least one of age, BMI, race, gender, ethnicity, education status, diseases, duration of illness, and insurance status.

8. The method of claim 1, further comprising:
computing interactions between (i) disease and age, (ii) disease and BMI and (iii) disease and duration of illness.

9. The method of claim 8, further comprising:
predicting expenditures for an individual on a basis of the computed interactions.

10. The method of claim 1, further comprising:
predicting a probability of having expenditures using binary logistic regression.

11. The method of claim 8, wherein estimating incremental and relevant lifetime costs includes (i) predicting expenditures for an individual on a basis of the computed interactions, (ii) predicting a probability of having expenditures using binary logistic regression and (iii) multiplying the predicted expenditures by the predicted probability.

12. The method of claim 2, further comprising:
calculating total expenditures by summing facility and physician expenditures and converting the calculated total expenditures to a natural log.

13. The method of claim 12, wherein performing risk assessments using differential regression analysis includes analyzing relationships between the dependent variables, the independent variables, and the natural log.

14. The method of claim 2, further comprising:
computing interactions between (i) disease and age, (ii) disease and BMI and (iii) disease and duration of illness.

15. The method of claim 14, further comprising:
predicting expenditures for an overweight or obese individual (i) with the disease on a basis of the computed interactions and (ii) without the disease.

16. The method of claim 2, further comprising:
predicting, using binary logistic regression, a probability of having expenditures for an overweight or obese individual (i) with the disease and (ii) without the disease.

17. The method of claim 15, further comprising:
calculating a difference in expenditure by determining a difference between the predicted expenditures of the overweight or obese individual with the disease and the overweight or obese individual without the disease.

18. The method of claim 2, wherein the plurality of variables includes at least difficulties in standing, bending, reaching overhead physical limitations, house work limitations, and social and cogitative limitations.

19. The method of claim 2, wherein prevalence includes at least one of (i) individuals with inadequate activities of daily living (ADL) and functional limitations, and (ii) diseases among individuals with BMI body mass index (BMI) and age.

20. The method of claim 19, further comprising:
calculating the prevalence of individuals with ADL and functional limitations, among the overweight or obese individuals and the healthy weight individuals, using the plurality of variables.

21. The method of claim 15, further comprising:
predicting expenditures by age and BMI category to determine projected cost trajectories for populations in healthy, overweight and obese BMI categories.

22. The method of claim 21, further comprising:
comparing the projected cost trajectories to determine cost reductions associated with achieving a healthy BMI.
